(19) United States
(12) Patent Application Publication
(10) Pub. No.: US 2009/0326821 A1
(43) Pub. Date: Dec. 31, 2009

(54) EARTHQUAKE PREDICTION INFORMATION PROVISION SYSTEM, PORTABLE TERMINAL, EARTHQUAKE PREDICTION INFORMATION PROVISION METHOD, AND RECORDING MEDIUM

(76) Inventors: Tomonari Yomoda, Kanagawa (JP); Toshio Yoshida, Kanagawa (JP)

Correspondence Address: Mr. Jackson Chen, 6535 N. STATE HWY 161, IRVING, TX, 75039, US

(21) Appl. No.: 12/524,649

(22) PCT Filed: Jan. 9, 2008
(86) PCT No.: PCT/JP2008/050109

§ 371 Date: Jul. 27, 2009

(30) Foreign Application Priority Data
Jan. 30, 2007 (JP) 2007-019680

(51) Int. Cl. G01V 3/08; G06F 19/00; G06F 15/00

(52) U.S. Cl. 702/2; 702/188; 702/15

(57) ABSTRACT

A detection of an anomaly of geomagnetism and a collection of data are performed by using portable telephones. Direction variations measured by geomagnetic sensors mounted to the portable telephones are collected via data transmission lines for portable telephones, and the variations are observed for each area. Earthquake occurrence warning information is transmitted to a portable terminal of a collaborator for geomagnetism information provision in an area in which a number of occurrences of the variations is significantly large.

### TECHNICAL FIELD

The present invention relates to an earthquake prediction information provision system, and especially relates to an earthquake prediction information provision system that detects geomagnetic anomaly and collects data by using portable terminals. This application is based upon and claims the benefit of priority from Japanese Patent Application No. 2007-019680, and the disclosure of Japanese Patent Application No. 2007-019680 is incorporated herein in its entirely by reference.

### BACKGROUND ART

Various premonitory phenomena of a large scale epicentral earthquake are reported, such as, a deterioration of quality of video image on a television, a disappearance of birds, an appearance of an earthquake cloud, and an appearance of an earthquake light. However, a method for quantitatively observing these changes has not been established, and an observation of these changes has not been realized up to now because of a large cost.

For example, when an earthquake occurs, a variation of geomagnetism may occur in association with the earthquake. However, collection of information in many observation points has not been realized because a large cost is required and communication units are not easily available when the earthquake occurs. For this reason, there has not been an efficient and effective method for periodically and widely collecting information indicating geomagnetic anomaly which is one of the premonitory phenomena of earthquake.

In addition, in order to measure a change in geomagnetism by a portable terminal, the portable terminal is required to be fixed at a specified direction to measure a variation from a magnetic north direction as a reference direction.

As a related technique, Japanese Laid Open Patent Application (JP-P2003-215259A) discloses an information collection system and an earthquake prediction method.

In the related technique, a portable terminal mounting a magnetic sensor transmits geomagnetism information. A geomagnetism information processing center collects the geomagnetism information via base stations and networks to generate a geomagnetism information DB (Data Base). A geomagnetism map generation unit processes the geomagnetism information into a geomagnetism map. An earthquake prediction organization uses the geomagnetism map as information for predicting an earthquake and delivers earthquake prediction information (a warning declaration) to the portable terminal if necessary. In this manner, an earthquake prediction and publicity system is provided which collects the geomagnetism information from portable terminals in various locations, performs the prediction of earthquake based on the geomagnetism information, and delivers earthquake prediction information to the respective portable terminals.

Additionally, Japanese Laid Open Patent Application (JP-P2003-269965A) discloses a charger for portable terminal.

The charger for portable terminal includes a holder to which a portable terminal having a geomagnetic direction sensor is attached, charges a battery of the portable terminal attached to the holder, and includes a turntable mechanism unit supporting the holder such that the holder is rotatable in a horizontal plane. In this related technique, the charger itself has the turntable and transmits direction data of the portable terminal after a rotation to a specified direction.

Additionally, Japanese Laid Open Patent Application (JP-P2006-071348A) discloses a geomagnetic variation sensing device and a geomagnetic variation detecting device.

In this related technique, when there is no change in geomagnetism, an indicator needle is arranged at a specified position. When a change in geomagnetism occurs, a magnet receives a force depending on the change in geomagnetism. When the magnet receives the force depending on the change in geomagnetism, an up-down rotation ring and/or a left-right rotation ring rotate(s) in a direction depending on the received force. Accordingly, when the change in geomagnetism occurs, the magnet moves in accordance with the rotation(s) of the up-down rotation ring and/or the left-right rotation ring. An amount of light received by a light receiving element varies in accordance with the rotation(s) of the up-down rotation ring and/or the left-right rotation ring. Accordingly, an output of the light receiving element varies depending on the change in geomagnetism. In other words, the device is a simple device for predicting an occurrence of earthquake by observing a sensor at a single point and by observing tiny variation in magnetic field lines.

Additionally, Japanese Laid Open Patent Application (JP-P2006-279844A) discloses a portable terminal device, a charger, and a charging system.

In this related technique, a CPU of the portable terminal device performs a process to obtain identification data for authentication from a memory of the charger when the portable terminal device is electrically connected to the charger. When the identification data for authentication is obtained, the CPU compares the identification data for authentication with terminal device identification data stored in a memory. When the identification data for authentication agrees with the terminal device identification data, the CPU controls a switch such that electric power is supplied from the charger to a rechargeable battery. In addition, when the identification data for authentication does not agree with the terminal device identification data or when the identification data for authentication cannot be obtained, the CPU controls the switch such that the supply of electric power from the charger to the rechargeable battery is shutdown The data which are interchanged between the portable terminal device and the charger are “matching data of the portable terminal and the charger”. A purpose of interchanging the data is to realize that “the charger performs the charging only when the matching data of the portable terminal and the charger are matched to each other and does not perform the charging when the data are not matched”.

Additionally, Japanese Laid Open Patent Application (JP-A-Heisei 09-178864) discloses a geomagnetism detection device.

In this related technique, a control unit calculates geomagnetism data (a magnitude of geomagnetism, a horizontal intensity of the geomagnetism, vertical intensity of the geomagnetism, an inclination, and a ratio of the horizontal intensity and the vertical intensity) at a predetermined sampling interval T based on geomagnetism intensities respectively detected by a plurality of MR elements, and stores the calculated data in a RAM. At the same time, the control unit stores in the RAM, vibration waveform data which is detected by a vibration sensor at that time such that the vibration wave form data is associated with the calculated geomagnetism data. In addition, the control unit allows a comparison of theoretical geomagnetism data at an installation location of the device with the measured geomagnetism data, and judges whether an influence of external magnetism is small at the installation location. Moreover, when there is anomaly in the geomagnetism data, the control unit causes a sound generation unit to issue a warning and automatically shortens the sampling interval T to record the data in more detail. That is, the geomagnetism detection device observes the variation of geomagnetism in detail at the installation location of the device and presumes an existence of some earthquake phenomenon when the variation occurs.

Additionally, Japanese Laid Open Patent Application (JP-A-Heisei 10-014637) discloses a holding structure for a portable communication device.

In this related technique, when a telephone is hung and fixed on a wall, the telephone can be securely held by and fixed to a charger by fitting a latch lever which is biased with a torque greater than a force based on a weight of the telephone into a hole of the telephone and by using protruding portions of the telephone and the charger.

### DISCLOSURE OF INVENTION

A purpose of the present invention is to provide an earthquake prediction information provision system, a portable terminal, an earthquake prediction information provision method, and a recording medium which make it possible to collect observation data from respective wireless terminals by using geomagnetic sensors (compasses) respectively mounted to the wireless terminals and analyze the data.

An earthquake prediction information provision system according to the present invention includes a plurality of fixing devices, a plurality of portable terminals, and a summarization device. The plurality of fixing devices are installed at many points, are individually fixed at a specified position and at a specified direction, and register installation direction data indicating the specified direction. When connected to and fixed to any one of the plurality of fixing device, the plurality of portable terminals measure measurement direction data indicating an own direction by using a magnetic sensor and calculate difference data based on the installation direction data and the measurement direction data. The summarization device collects from each of the plurality of portable terminals, position information of the portable terminal and the difference data, and analyzes the difference data for each area (region). When detecting an anomaly of magnetic variation, the summarization device transmits earthquake prediction information to a portable terminal existing in an area in which the anomaly is detected.

A portable terminal according to the present invention includes a link unit, a magnetic sensor, a processing unit, and a communication unit. The link unit performs data communication with a fixing device that is fixed at a specified position and at a specified direction. The magnetic sensor measures a direction of the portable terminal by observing geomagnetism. The processing unit registers installation direction data indicating the specified direction to the fixing device, obtains the installation direction data from the fixing device when the portable terminal is fixed to the fixing device, and calculates difference data between measurement direction data measured by the magnetic sensor and the installation direction data. The communication unit transmits position information of the portable terminal and the difference data to a summarization device which summarizes and analyzes the difference data for each area, and receives earthquake prediction information from the summarization device when the summarization device detects an anomaly of magnetic variation in an area in which the portable terminal exists.

An earthquake prediction information provision method according to the present invention is performed in the following procedure. At first, a normal position of a compass is registered to a fixing device which is fixed at a specified position. Next, a portable terminal is fixed to the fixing device, and a difference is measured between the magnetic direction registered to the fixing device and a current direction measured by the portable terminal by using a magnetic sensor. Next, the measured data and position information of the portable terminal are transmitted to a summarization device when the portable terminal has not been moved for a predetermined period of time. Next, the summarization device summarizes the measured data for each reception area to calculate an error from a magnetic north. And next, when an extent of magnetic variation exceeds a reference value in a predetermined area, the summarization device transmits earthquake prediction information to a portable terminal in the predetermined area.

Even though an accuracy of measurement by each portable terminal is poor, since the number of subscribers of portable terminals is overwhelmingly larger than the number of seismographs and other observing apparatuses, a trend of geomagnetism, a tendency of geomagnetic variation and a detailed value of geomagnetism in an entire area can be obtained based on averaged data for a number of measurement points.

### BRIEF DESCRIPTION OF DRAWINGS

FIG. 1 is a conceptual illustration to illustrate an earthquake prediction information provision system according to the present invention;

FIG. 2 is illustration showing tendencies of magnetic variation in respective control station areas;

FIG. 3 is a block diagram showing configurations of a portable terminal and a charger according to the present invention;

FIG. 4 is a view showing a state in which the portable terminal is fixed to the charger; and

FIG. 5 is a flowchart showing an operation of the earthquake prediction information provision system according to the present invention.

### BEST MODE FOR CARRYING OUT THE INVENTION

In the present invention, measurement results of direction variation measured by geomagnetic sensors mounted to portable terminals are collected via data transmission lines for the portable terminals, the variation is observed in each area (region), and thus, earthquake occurrence warning information is transmitted to a portable terminal of a collaborator for geomagnetism information provision in an area in which a number of occurrences of the variations is significantly large.

Referring to the attached drawings, a first exemplary embodiment of the present invention will be explained below.

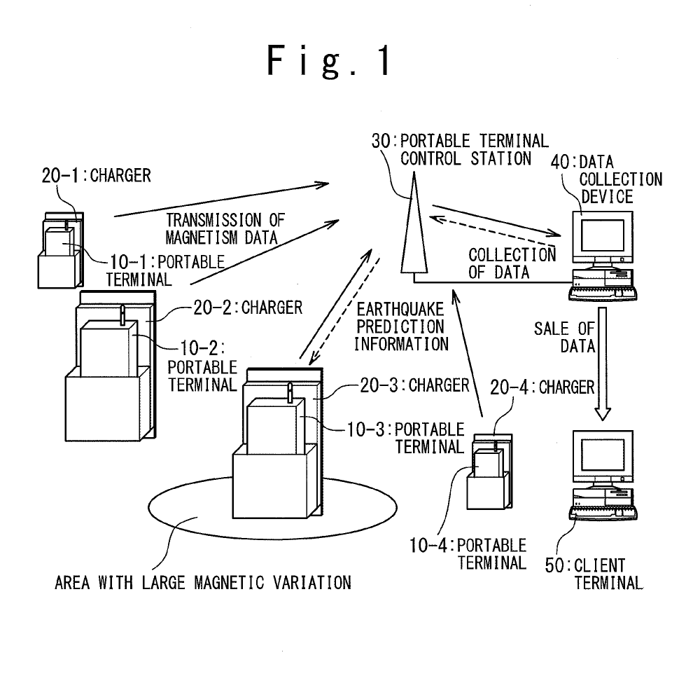

As shown in FIG. 1, an earthquake prediction information provision system according to the present invention includes portable terminals 10, chargers 20, portable terminal control stations 30, a data collection device 40, and a client terminal 50.

The portable terminal 10 (10-i, i=1 to n: n is the number of the terminals) is a portable communication terminal which performs wireless communication. In addition, the portable terminal 10 can be fixed to the charger 20, and is charged by the charger 20. The portable terminal 10 transmits magnetism data to the portable terminal control station 30, and receives earthquake prediction information from the portable terminal control station 30. Here, a portable telephone is assumed to be used as the portable terminal 10. However, the portable terminal 10 is not actually limited to the portable telephone. For example, a PDA (Personal Digital Assistants), a digital camera, a laptop computer, a portable gaming machine, a portable music player, a portable television or a portable DVD player may be used as the portable terminal 10. The larger the number of the portable terminals 10 according to the present invention is, the better, and accordingly it can be considered that universally prevalent various apparatuses are used.

Meanwhile, it is preferred that the portable terminal 10 is a wireless communication terminal, however, an implementation of the present invention is possible even when the portable terminal 10 is a wire communication terminal.

The charger 20 (20-i, i=1 to n) is a device used to charge a power supply of the portable terminal 10. The charger 20 is fixed to an arbitrary location such as a wall surface such that a position to which the portable terminal 10 is inserted is certainly constant with respect to a direction when the portable terminal 10 is charged. The number of the chargers 20 is the same as that of the portable terminal 10, preferably. That is because the portable terminal 10 and the charger 20 are used as a unit in the present invention. However, the number of the chargers 20 may not actually be the same as that of the portable terminal 10. For example, when a plurality of the portable terminals 10 can be inserted in the single charger 10, the number of the chargers 20 may not be the same as that of the portable terminal 10.

The portable terminal control station 30 (30-j, j=1 to m: m is the number of the stations) communicates with the portable terminal 10 by wireless communication. However, the portable terminal control station 30 may actually communicate with the portable terminal 10 by wire communication. Here, the portable terminal control station 30 receives the magnetism data from the portable terminal 10, and transmits the earthquake prediction information to the portable terminal 10 in an area (a region) in which magnetic variation is large. A relay apparatus such as a base station, an access point, an exchange, and a router, and a server, or, a server such as a gateway server and a DNS (Domain Name System) server which are accessed at a high provability from the communication terminal during communication is considered as an example of the portable terminal control station 30.

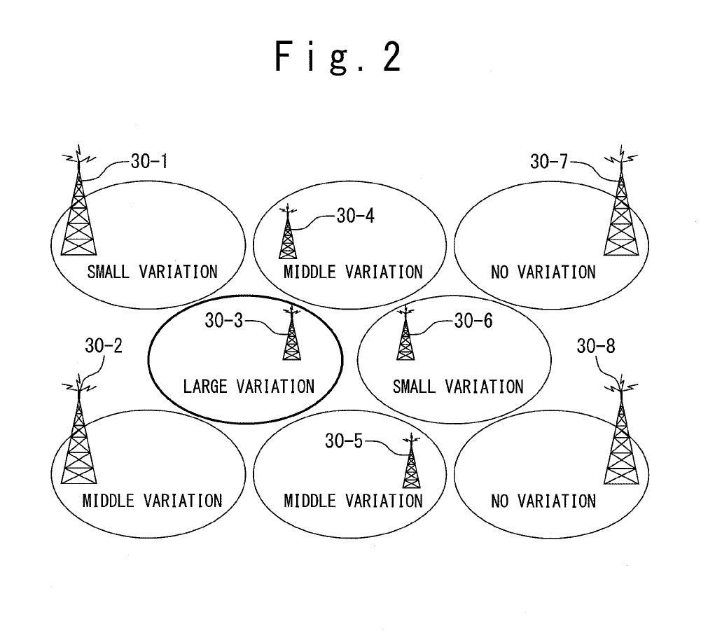

FIG. 2 shows tendencies of magnetic variation in respective control station areas. The control station area is an area in which the portable terminal 10 and the portable terminal control station 30 can communicate with each other. For example, when the portable terminal control station 30 is a base station, the control station area is a communication cell (an area covered by one base station). Here, “large”, “middle”, “small”, and “no” are shown in the descending order of magnetic variation. In the present exemplary embodiment, the portable terminal control station 30 in an area in which the variation is “large” transmits the earthquake prediction information to the portable terminal 10 existing in the area. On this occasion, the earthquake prediction information may be transmitted to the portable terminal 10 existing in an area in which the variation is “middle” or higher.

The data collection device 40 obtains magnetism data collected by the portable terminal control stations 30, generates the earthquake prediction information based on the obtained magnetism data, and transmits the generated earthquake prediction information to the portable terminal control stations 30. On this occasion, the data collection device 40 may communicate with the portable terminals 10 via the portable terminal control stations 30. By the way, the portable terminal control stations 30 and the data collection device 40 may be provided as a device. Here, a combined device including the portable terminal control stations 30 and the data collection device 40 is referred to as a summarization device. However, the summarization device may actually refer to any one of the portable terminal control station 30 and the data collection device 40.

The client terminal 50 is a communication terminal used by a client other than owners of the portable terminals 10. The client asks for the earthquake prediction information. The client pays a fee to a company providing a service that uses the earthquake prediction information provision system according to the present invention, and thus, the client terminal 50 receives the earthquake prediction information from the data collection device 40. A sale of the earthquake prediction information is an example, and the payment of the fee is not necessarily required.

Next, examples of the present exemplary embodiment will be explained.

Firstly, when the charger 20 fixed to an arbitrary location is installed, initial registration of “charger installation direction data” is performed. The initial registration of the “charger installation direction data” is performed by the portable terminal 10 which uses the charger 20 or by another communication terminal which can communicate with the charger 20. In addition, the charger 20 itself may include an input device for the setting. In this manner, the “charger installation direction data” is registered in the charger 20 in advance and the charger 20 outputs the “charger installation direction data” at every time when the portable terminal 10 is inserted into the charger 20.

After the portable terminal 10 is inserted into the charger 20 and receives the “charger installation direction data” from the charger 20, the portable terminal 10 temporarily records the “charger installation direction data”, and measures and records “portable terminal direction sensor data”. The portable terminal 10 reads the recorded “charger installation direction data” and “portable terminal direction sensor data”, and checks the “charger installation direction data” and “portable terminal charger fixation direction sensor orientation data” registered in advance for each type of the portable terminal 10 to calculates “portable terminal charger installation direction data theoretical value”. The portable terminal 10 checks the calculated “portable terminal charger installation direction data theoretical value” and the “portable terminal direction sensor data” to calculate “difference between the theoretical value and the measurement direction data”. The portable terminal 10 transmits the above-obtained “charger installation direction data”, “portable terminal direction sensor data”, “portable terminal charger direction data”, and “difference between the theoretical value and the measurement direction data” to a preliminarily determined destination. Here, the preliminarily determined destination is the data collection device 40. The portable terminal 10 sends the respective data to the data collection device 40 via the portable terminal control station 30. In addition, it is possible that the destination is the portable terminal control station 30 and the portable terminal control station 30 receives the respective data from the portable terminal and transfers the data as it is to the data collection device 40.

The “portable terminal charger fixation direction sensor orientation data” indicates a direction in a situation that the portable terminal 10 is fixed to the charger 20. Here, the data indicates a direction when the portable terminal 10 is fixed to the charger 20 for the first time, that is, an initially-registered direction. On this occasion, it is preferred that the charger 20 is a charger most frequently used by the portable terminal 10. However, the portable terminal 10 may actually register the “portable terminal charger fixation direction sensor orientation data” for each of all chargers to which the portable terminal 10 may be connected and fixed based on identification information of each charger.

As an example of a method of the initial registration of the “charger installation direction data”, a following method can be considered. At first, an installation worker or a user prepares a construction drawing of a building having an installation wall surface and the like, and accurately reads 360°-direction data of the installation surface for the charger 20 from the construction drawing by using a protractor. Here, a true north direction on a map is defined to be 0°. Then, the installation worker or the user inputs the read direction data as the “charger installation direction data” by using an input screen of the portable terminal 10 in which an application for inputting the charger installation surface direction is installed in advance. After that, the installation worker or the user inserts the portable terminal 10 in the charger 20 after switching the terminal to be a mode of data transmission to the charger 20. When inserted in the charger 20, the portable terminal 10 transmits the “charger installation direction data” to the charger 20. The charger 20 stores the received “charger installation direction data” in a memory. However, the method is not actually limited to the above-mentioned example. For example, when the charger 20 is installed, the portable terminal 10 may obtain 360°-direction data of the installation surface of the charger 20 in a state that the portable terminal 10 is inserted in the charger 20 and input the obtained direction data as the “charger installation direction data” to the charger 20. Here, a true north direction is defined as 0°. Here, the “charger installation direction data” serves as a reference direction of the portable terminal 10.

The reason why the construction drawing is used without using a compass is that data required for the earthquake prediction is not direction data indicated by a compass in the site but a “difference between an accurate direction on a map and a direction indicated by a compass in the site” When the reference direction of the portable terminal 10 is determined by using the compass, the reference direction is the same as a result measured by a magnetic sensor incorporated in the portable terminal 10, thereby the measurement becomes meaningless.

An accurate reference direction at a measurement site is essential for the earthquake prediction, and according to this method, the “difference between the accurate direction on the map and the direction indicated by the compass in the site” can be calculated based on the accurate reference direction.

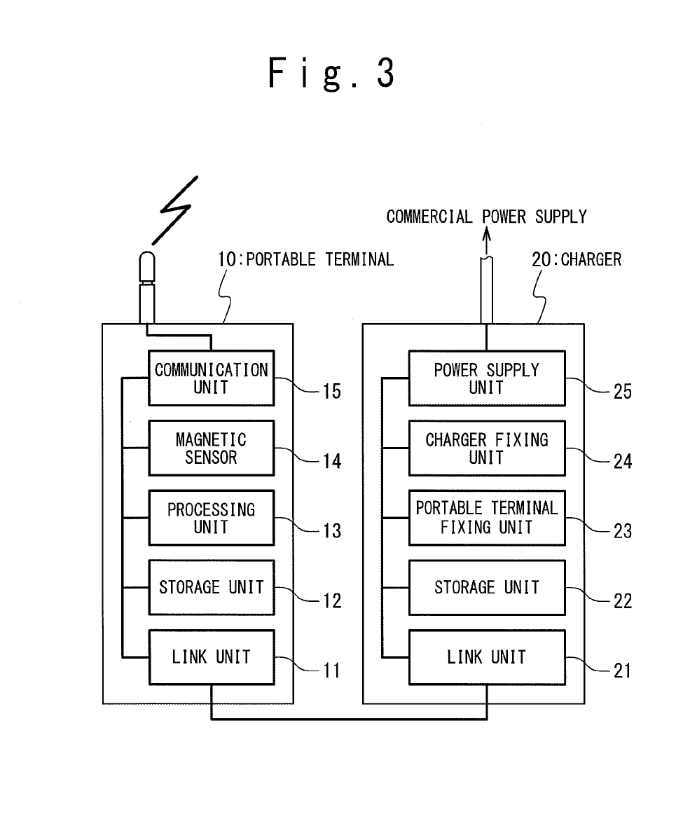

Next, referring to FIG. 3, a configuration of the portable terminal 10 according to the present invention will be explained.

The portable terminal 10 includes a link unit 11, a storage unit 12, a processing unit 13, a magnetic sensor 14, and a communication unit 15. However, the portable terminal 10 does not always include these components actually. For example, peripheral devices of the portable terminal 10 may include these components. Or, an expansion card such as a network adapter may include these components.

The link unit 11 is a link portion such as a charging terminal and an infrared modem transceiver which enable a data communication between the portable terminal 10 and the charger 20. It is preferred that the link unit 11 can perform a near field wireless communication. A contactless IC card function, an IrDA (Infrared Data Association), a Bluetooth (registered trademark), and a wireless LAN (Local Area Network) can be considered as examples of the near field wireless communication. However, the communication is not actually limited to these examples. For example, a serial communication in which the portable terminal 10 is connected to the charger 20 via a communication cable may be employed. The portable terminal 10 performs the data communication with the charger 20 via the link unit 11. Here, the link unit 11 obtains the “charger installation direction data” from the charger 20.

The storage unit 12 stores: data transmitted and received in the data communication between the portable terminal 10 and the charger 20; and data transmitted to a preliminarily determined destination. The preliminarily determined destination is the portable terminal control station 30 or the data collection device 40 with which the portable terminal 10 can communicate via the portable terminal control station 30. For example, a storage device such as a memory and a storage or a recording medium can be considered as the storage unit 12. Here, the storage unit 12 stores the “charger installation direction data”, the “portable terminal direction sensor data”, the “portable terminal charger fixation direction sensor orientation data”, and the “difference between the theoretical value and the measurement direction data”. The “portable terminal charger fixation direction sensor orientation data” is registered for each type of the portable terminal 10 in advance.

The processing unit 13 controls the inside of the portable terminal 10 and processes various type of data. For example, a processor such as a CPU can be considered. In addition, the processing unit 13 interchanges, as necessary, various type of data with an input device which is operated by the user of the portable terminal 10 to input data and a display for displaying contents corresponding to the various type of data. For example, as the input device and the display device, an operation key and an LCD (a liquid crystal display), a key pad on a screen, or a touch panel can be considered. The input device and the display device are not always mounted to the portable terminal 10. For example, the input device and the display device may be peripheral devices of the portable terminal 10. In addition, the various types of data inputted to the processing unit 13 are not limited to the data inputted by the user, but may be data inputted from other communication terminals. Here, the processing unit 13 checks the “charger installation direction data” and the “portable terminal charger fixation direction sensor orientation data” to calculate the “portable terminal charger installation direction data theoretical value”. The processing unit 13 checks the calculated “portable terminal charger installation direction data theoretical value” and the “portable terminal direction sensor data” to calculate the “difference between the theoretical value and the measurement direction data”. The processing unit 13 stores the calculated “difference between the theoretical value and the measurement direction data” in the storage unit 12.

The magnetic sensor 14 is a sensor for measuring geomagnetism and observing the magnetic variation. Here, the magnetic sensor 14 measures the geomagnetism, and stores magnetism data indicating the measured geomagnetism in the storage unit 12. This magnetism data serves as the “portable terminal direction sensor data”.

The communication unit 15 performs the data communication between the portable terminal 10 and the portable terminal control station 30. The “charger installation direction data”, the “portable terminal direction sensor data”, the “portable terminal charger direction data”, and the “difference between the theoretical value and the measurement direction data” are interchanged between the portable terminal 10 and the portable terminal control station 30. Here, the communication unit 15 obtains the “charger installation direction data”, the “portable terminal direction sensor data”, the “portable terminal charger direction data”, and the “difference between the theoretical value and the measurement direction data” as various types of data, and transmit the obtained various types of data to the portable terminal control station 30.

Next, referring to FIG. 3, a configuration of the charger 20 according to the present invention will be explained.

The charger 20 includes a link unit 21, a storage unit 22, a portable terminal fixing unit 23, a charger fixing unit 24, and a power supply unit 25. These components are not always mounted to the charger 20, and may be peripheral devices.

The link unit 21 is a link portion such as a charging terminal and an infrared modem transceiver which enable a data communication between the portable terminal 10 and the charger 20. It is preferred that the link unit 21 can perform a near field wireless communication. A contactless IC card function, an IrDA, a Bluetooth (registered trademark), and a wireless LAN can be considered as examples of the near field wireless communication. However, the communication is not actually limited to these examples. For example, a serial communication in which the portable terminal 10 is connected to the charger 20 via a communication cable may be employed. The charger 20 performs the data communication with the portable terminal 10 via the link unit 21. On this occasion, the data communication is performed between the link unit 11 and the link unit 21. Here, the link unit 21 obtains the “charger installation direction data” from the storage unit 22, and transmits the obtained “charger installation direction data” to the link unit 11.

The storage unit 22 stores the respective data transmitted and received in the data communication between the portable terminal 10 and the charger 20. For example, a storage device such as a memory and a storage or a recording medium can be considered as the storage unit 22. Here, the storage unit 22 stores the “charger installation direction data”. However, when the portable terminal 10 directly detects and obtains the “charger installation direction data”, the storage unit 22 can be omitted since the storage unit 22 is common with the storage unit 12.

The portable terminal fixing unit 23 is a portion to fix the portable terminal 10 inserted in the charger 20. For example, a case (a housing) provided to the charger 20 for housing the portable terminal 10 and a hook can be considered. The portable terminal 10 and the charger 20 may be configured so as to be fitted one another. On this occasion, a function for detecting the fixing of the portable terminal 10 may be provided to the portable terminal fixing unit 23 to allow the data communication between the portable terminal 10 and the charger 20 only when the portable terminal 10 is fixed. Meanwhile, instead of the providing of the fixing unit 23, the portable terminal 10 and charger 20 may be configured such that a charging and the data communication between the portable terminal 10 and the charger 20 are allowed only when the portable terminal 10 and the charger 20 are set in a specified relative orientation. In addition, the portable terminal 10 and the charger 20 may be connected by a hard cable (a hard transmission path) or the like which cannot be bent.

The charger fixing unit 24 is a portion to fix the charger 20 on the wall surface or the like, and includes a portion of a body of the charger 20, which contacts the wall surface or the like. For example, a fixing screw, an adhesive tape, a frame on the wall surface, and a hook can be considered as a tool to fix the charger 20. When the charger 20 is fixed by a portion of the wall surface or when the charger 20 is embedded in the wall surface, the charger fixing unit 24 represents a portion fixed by the wall surface. However, a location to which the charger 20 is fixed is not actually limited to the wall surface. For example, the location may be on a floor or a desk. On this occasion, a function for detecting a fixing state of the charger 20 may be provided to the charger fixing unit 24 to notify the portable terminal 10 of the state and not to allow the data communication between the portable terminal 10 and charger 20 when the charger fixing unit 24 is in an unfixed state for some reason.

The power supply unit 25 is connected to a commercial power supply, and is a power supply cable and/or an electrical storage device for supplying electric power to the charger 20. The power supply cable may be wired or wireless. Meanwhile, when the charger 20 is a charger which charges the portable terminal 10 by a battery without using a power supply cable, the power supply unit 25 represents a housing unit of the battery.

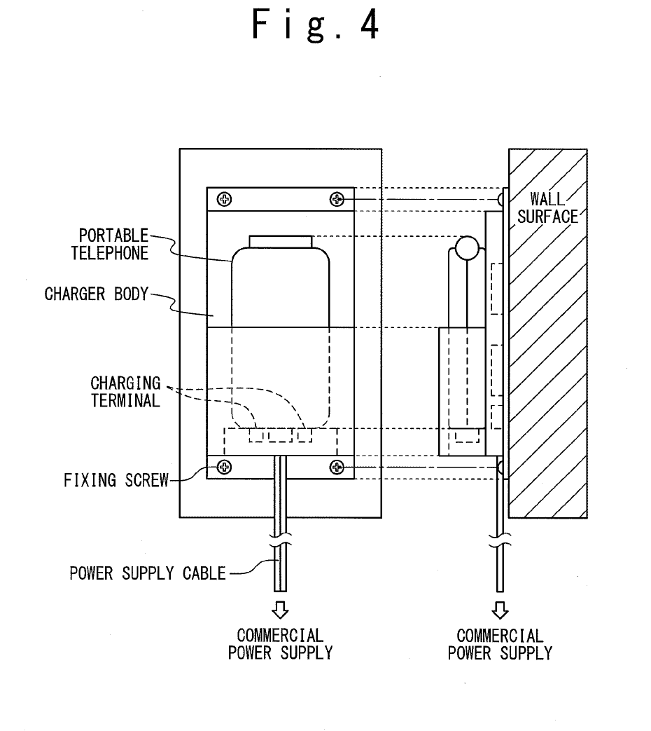

FIG. 4 shows a state of the charger 20 which is fixed on the wall surface, fixes the portable terminal 10 and charges the portable terminal 10. Here, an explanation will be given in which a portable telephone is used as an example.

In FIG. 4, “portable telephone” represents the portable terminal 10, “charger body” represents the charger 20, “charging terminal” represent the link unit 11 and the link unit 21, “fixing screw” represents the charger fixing unit 24, and “power supply cable” represents the power supply unit 25, respectively. On this occasion, the “charger body” is fixed on the wall surface by the “fixing screw” and is supplied with electric power from the commercial power supply via the “power supply cable” In addition, the “charger body” houses and fixes the “portable telephone”. The “portable telephone” and the “charger body” are in contact with each other at the “charging terminal”. Meanwhile, in a case of contactless type, they are not required to be in contact with each other. When the “charger body” is installed and fixed on a location, a magnetic north at the location measured by the “portable telephone” is set to the “portable telephone”. Thereafter, when the “portable telephone” is inserted in the charger, direction data of a vector difference between the preliminarily-set magnetic north and a current magnetic north is transmitted with GPS (Global Positioning System) information of the “portable telephone”. The GPS information is position information of the “portable telephone” obtained by a GPS. However, position information other than the GPS information may be transmitted.

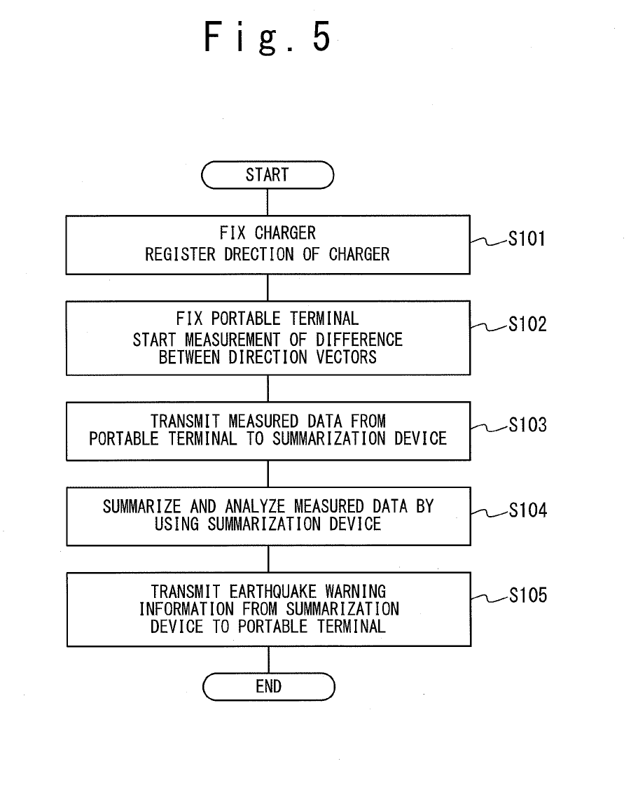

Referring to FIG. 5, an operation of the earthquake prediction information provision system according to the present invention will be explained. Here, the operation will be explained by using the installation of the portable terminal 10 as an example.

The compass of the portable terminal 10 is configured to point the south and the north; however, information required is a geomagnetic disturbance (magnetic anomaly). Here, by collecting the disturbance of magnetic direction at a fixed point, a resultant vector of the magnetic disturbance and a geomagnetic direction at the observation point can be known. For this reason, the portable terminal 10 has to be fixed to a determined position.

(1) Step S101

The charger 20 of the portable terminal 10 is fixed to a predetermined wall or to a predetermined outlet (a predetermined plug socket), and a normal (basic state) position of the compass (a normal magnetic direction) is preliminarily registered to the charger 20. Here, the outlet represents a socket of an insertion connector used for connecting a house wiring and an electric appliance code. The magnetic north in a case in which the portable terminal 10 is fixed is not necessarily required to point the north. For example, even when an iron or a magnetic body exists near the fixation location, it is required only that: a vector sum of a direction of magnetic force of the iron or the magnetic body and a geomagnetic direction can be found; and a change of vector caused by the magnetic anomaly added to the vector sum can be observed. Meanwhile, the magnetic body is a body able to be magnetized.

(2) Step S102

When the portable terminal 10, in order to charge the terminal at home or outside the home, is fixed to the charger 20 which is fixed in advance and to which the magnetic direction is set, the portable terminal 10 starts measuring a difference between the magnetic direction set to the charger 20 and a current magnetic direction. It is preferred that the magnetic sensor is a three dimensional sensor which is able to perform the measurement in right, left, up, and down directions. The portable terminal 10 may be configured to perform the measurement periodically (at a constant time interval) during being fixed.

(3) Step S103

Even when the measured data has no error, the portable terminal 10 transmits the measured data to the portable terminal control station 30 when the portable terminal 10 has not been moved for a predetermined period of time. In addition, when the portable terminal 10 mounts the GPS function, the portable terminal 10 transmits latest position obtaining information of the GPS in addition to the data to the portable terminal control station 30. Meanwhile, the position information can be obtained by a function other than the GPS. On this occasion, identification information of the portable terminal control station 30 that transmits and receives the data may be added to the data. The portable terminal control station 30 transmits the data transmitted from the portable terminal 10 to the data collection device 40.

(4) Step S104

The data collection device 40 summarizes the data for each reception area and calculates an error from the magnetic north. In addition, the data collection device 40 transmits the collected data to a research institute such as the Japan Meteorological Agency, an auxiliary organization of the Japan Meteorological Agency, and a university, and collects results made by combining the collected data with other earthquake prediction information. Or, the data collection device 40 may obtain other earthquake prediction information from the research institute and combine the collected data with the other earthquake prediction information.

(5) Step S105

When an extent of the variation exceeds a reference value in a certain area, the data collection device 40 transmits the earthquake warning information (earthquake prediction information) to the portable terminals 10 in the area via the portable terminal control station 30. That is, the portable terminal 10 receives the earthquake warning information in return for the provision of the magnetism information. Meanwhile, as the earthquake warning information, textual information such as a message, sound information such as warning and alarm, image information such as an icon and a dynamic image, and a signal to cause a light source to blink can be considered. In addition, the portable terminal 10 may be configured to perform a special operation in response to the earthquake warning information.

The present exemplary embodiment has been explained by using a combination of the portable terminal and the charger as an example, however, this is an exemplification and accordingly the present exemplary embodiment is not actually limited to the combination of the portable terminal and the charger. For example, the present invention can be implemented as a combination of a peripheral device such as an USB memory and a desktop PC (personal computer). In this case, the peripheral device corresponds to the portable terminal 10, and the desktop PC corresponds to the charger 20. It is preferred that the peripheral device has a wireless communication function; however, the peripheral device may use a communication function of the desktop PC. Input and display of data are performed by using a keyboard and a display connected to the desktop PC. Specifically, when the peripheral device corresponds to the portable terminal 10, it can be considered that components mounted on the desktop PC are used as the processing unit 13, the magnetic sensor 14, and the communication unit 15. For example, this enables the desktop PC to transmit magnetism data when a predetermined USB is inserted in the desktop PC.

Next, a second exemplary embodiment of the present invention will be explained.

The charger 20 fixes the portable terminal 10. When a plurality of chargers 20 are shared or when a plurality of portable terminal 10 are charged by a charger 20, an ID number is assigned to the charger 20 and a charging is performed, and thus, the portable terminal 10 recognizes the charger 20 in which the portable terminal 10 is inserted, recognizes a magnetic direction set for the charger 20, and measures an error.

Next, a third exemplary embodiment of the present invention will be explained.

In the present invention, more plenty information can be collected by providing the same function to: a mobile terminal and a vending machine which have communication units; a television, a telephone, a personal digital electronics, a refrigerator and a home security system which are able to connect to the Internet; and a fixed communication device (a fixed terminal) such as a doorphone system, in addition to the portable terminal 10. These are the same as in the case that the portable terminal 10 and the charger 20 are originally configured as a unit.

Next, a fourth exemplary embodiment of the present invention will be explained.

In the present invention, for example, a power supply device such as an outlet (a plug socket), a UPS (Uninterruptible Power Supply), a PLC modem (Power Line Communication Modem), a fixed communication modem, a switching hub, and a router may be used in addition to the charger 20. In this case, communication terminals (connection terminals) connected to these devices correspond to the portable terminals 10. It is preferred that the connection terminals are fixed to these devices. Actually, when the connection terminal is connected to such device, the connection terminal is usually used at a specified position such as a user's desk in an office, a desk at home and a table at home even when the connection terminal is a communication terminal able to perform a wireless communication. This is the same as that the position is fixed.

Finally, features of the present invention will be explained.

In the present invention, the magnetic north of the portable terminal at the measurement point is determined, and the variation of the magnetic north is observed. In the present invention, the portable terminal detects the magnetic variation and sends the data with the position information to the summarization device. In the present invention, the summarization device analyzes the sent data. In the present invention, the summarization device analyzes an earth current causing the variation of geomagnetism based on the data of the resultant vector with the magnetic north and predicts an earthquake occurrence. In the present invention, the data obtained through the analysis and the prediction by the summarization device is sold to the client In the present invention, the earthquake warning information is provided to the owners of the portable terminals, who collaborate in the data collection.

As described above, the earthquake prediction information provision system of the present invention performs the earthquake prediction by: summarizing the difference data between direction data measured by the portable terminals inserted in the chargers that are installed in many points and the on-map direction theoretical values; and observing a long term variation of the difference data on a large ground surface.

The earthquake prediction information provision system according to the present invention collects and analyzes a large amount of observation data by using the magnetic sensor (compass) mounted to the wireless terminal. As examples of the wireless terminal, a communication terminal using a communication method such as a telecommunications carrier's line, a FOMA (Freedom Of Mobile multimedia Access), a PDC (Personal Digital Cellular), a CDMA (Code Division Multiple Access) 1, and a PHS (Personal Handyphone System) can be considered. The earthquake prediction information provision system according to the present invention instantaneously provides the earthquake warning information to the portable terminals in an area in which a geomagnetic anomaly was detected. The earthquake prediction information provision system according to the present invention fixes the charger for the portable terminal, registers a location where the charger is fixed as a fixed observation point, and observes variation of the geomagnetism at the fixed observation point. The earthquake prediction information provision system according to the present invention sends installation direction data of the charger to the portable terminal to be charged.

1-15. (canceled)

16. An earthquake prediction information provision system comprising:
a plurality of fixing devices which are installed at a plurality of points, are individually fixed at a specified position and at a specified direction, and register installation direction data indicating said specified direction;
a plurality of portable terminals which measure measurement direction data indicating an own direction by using a magnetic sensor and calculate difference data based on said installation direction data and said measurement direction data when connected to and fixed to any one of said plurality of fixing device; and
a summarization device which collects from each of said plurality of portable terminals, position information of each of said plurality of portable terminals and said difference data, analyzes said difference data for each area, and transmits earthquake prediction information to a portable terminal which exists in an area when detecting an anomaly of magnetic variation in said area.

17. The earthquake prediction information provision system according to claim 16, wherein when a magnetic body exists near said fixing device, said each of said plurality of portable terminal measures said measurement direction data in consideration of a vector sum of a direction of magnetic force of said magnetic body and a geomagnetic direction.

18. The earthquake prediction information provision system according to claim 16, wherein said each of said plurality of fixing devices has identification information, and
when connected to any one of said plurality of fixing devices, said each of said plurality of portable terminals recognizes said any one of said plurality of fixing devices by checking said identification information, obtains installation direction data registered to said any one of said plurality of portable terminals and calculate difference data based on said installation direction data and said measurement direction data.

19. The earthquake prediction information provision system according to claim 16, wherein at least one of said plurality of fixing devices is a charger,
at least one of said plurality of portable terminals is a charged terminal which is charged by said charger, and
said charged terminal obtains said installation direction data from said charger when fixed to said charger, calculates said difference data by measuring said measurement direction data by using a magnetic sensor mounted to said charged terminal, and transmits position information of said charged terminal and said difference data to said summarization terminal, and receives said earthquake prediction information from said summarization device when said summarization device detects an anomaly of magnetic variation in an area in which said charged terminal exists.

20. The earthquake prediction information provision system according to claim 16, further comprising a fixed communication device which is fixed at a specified position and at a specified direction, registers installation direction data indicating said specified direction, measures measurement direction data by using a magnetic sensor, calculates difference data based on said installation direction data and said measurement direction data, and transmits position information of said fixed communication device and said difference data to said summarization device.

21. The earthquake prediction information provision system according to claim 16, wherein said each of said plurality of portable terminals has fixation direction data indicating a direction in a situation that said each of said plurality of portable terminals is fixed to a predetermined fixing device, calculates a direction data theoretical value by checking said installation direction data and said fixation direction data, and calculates said difference data by checking said direction data theoretical value and said measurement direction data.

22. A portable terminal comprising:
a link unit for performing data communication with a fixing device which is fixed at a specified position and at a specified direction;
a magnetic sensor for measuring a direction of said portable terminal by observing geomagnetism;
a processing unit for registering installation direction data indicating said specified direction to said fixing device, obtaining said installation direction data from said fixed device when said portable terminal is fixed to said fixing device, and calculating difference data between measurement direction data measured by said magnetic sensor and said installation direction data; and
a communication unit for transmitting position information of said portable terminal and said difference data to a summarization device which summarizes and analyzes said difference data for each area, and receiving said earthquake prediction information from said summarization device when said summarization device detects an anomaly of magnetic variation in an area in which said portable terminal exists.

23. The portable terminal according to claim 22, wherein when a magnetic body exists near the said fixing device, said processing unit measures said measurement direction data in consideration of a vector sum of a direction of magnetic force of said magnetic body and a geomagnetic direction.

24. The portable terminal according to claim 22, further comprising a storage unit for storing fixation direction data indicating a direction in a situation that said portable terminal is fixed to said fixing device, and
wherein said processing unit calculates a direction data theoretical value by checking said installation direction data and said fixation direction data, and calculates said difference data by checking said direction data theoretical value and said measurement direction data.

25. An earthquake prediction information provision method comprising:
registering a normal position of a compass to a fixing device which is fixed at a specified position;
fixing a portable terminal to said fixing device;
measuring a difference between a magnetic direction registered to said fixing device and a current direction measured by said portable terminal by using a magnetic sensor;
transmitting measured data and position information of said portable terminal to a summarization device when said portable terminal has not been moved for a predetermined period of time;
summarizing said measured data for each reception area to calculate an error from a magnetic north by using said summarization device; and
transmitting earthquake prediction information from said summarization device to said portable terminal in a predetermined area when an extent of magnetic variation exceeds a reference value in said predetermined area.

26. The earthquake prediction information provision method according to claim 25, further comprising measuring a current direction by using said magnetic sensor in consideration of a vector sum of a direction of magnetic force of a magnetic body and a geomagnetic direction when said magnetic body exists near said fixing device.

27. The earthquake prediction information provision method according to claim 25 further comprising:
registering to said portable terminal, fixation direction data indicating a direction in a situation that said portable terminal is fixed to said fixing device;
calculating a direction data theoretical value by checking installation direction data indicating a normal position of a compass for said fixing device and said fixation direction data; and
calculating a difference by checking said direction data theoretical value and measurement direction data indicating a current direction which is measured by said magnetic sensor.

28. A recording medium which holds a program to cause a computer to execute:
performing a data communication with a fixing device which is fixed at a specified position and at a specified direction;
measuring a direction of the computer by observing a geomagnetism;
registering installation direction data indicating said specified direction to said fixing device;
obtaining said installation direction data from said fixing device when the computer is fixed to said fixing device;
calculating difference data between measurement direction data measured by said magnetic sensor and said installation direction data;
transmitting position information of the computer and said difference data to a summarization device which collets and analyzes said difference data for each area; and
receiving said earthquake prediction information from said summarization device when said summarization device detects an anomaly of magnetic variation in an area in which the computer exists.

29. The recording medium according to claim 28, which holds the program to cause the computer to further execute measuring said measurement direction data in consideration of a vector sum of a direction of a magnetic force of a magnetic body and a geomagnetic direction when said magnetic body exists near said fixing device.

30. The recording medium according to claim 28, which holds the program to cause the computer to further execute:
storing fixation direction data indicating a direction in a situation that the computer is fixed to said fixing device;
calculating a direction data theoretical value by checking said installation direction data and said fixation direction data;
calculating said difference data by checking said direction data theoretical value and said measurement direction data.
